(19) United States
(12) Patent Application Publication
(10) Pub. No.: US 2010/0333188 A1
(43) Pub. Date: Dec. 30, 2010

(54) Method for protecting networks against hostile attack

(76) Inventor: Timothy J. Politowicz, Great Meadows, NJ (US)

Correspondence Address: Docket Administrator (Room 2F-192);Alcatel Lucent, 600 Mountain Avenue, Murray Hill, NJ, 07974-0636, US

(21) Appl. No.: 12/459,286

(22) Filed: Jun. 29, 2009

(51) Int. Cl. G06F 21/00; G06F 17/00; H04L 9/00

(52) U.S. Cl. 726/13; 713/162

(57) ABSTRACT

An address-hopping method is provided to enhance security in computer networks. In embodiments, the method is carried out at a network node and includes storing an IP address that is temporarily valid as a destination address for the node; sequentially updating the stored IP address, at least at specified intervals of time, with new values that are each temporarily valid; and conditionally accepting or rejecting incoming packets according to whether there is a match between the destination IP address of the incoming packet and the temporarily valid IP address currently stored in the memory.

### FIELD OF THE INVENTION

The invention relates generally to Internet Protocol (IP) networks, and more generally to the management of IP addresses in such networks.

### ART BACKGROUND

Computer networks are known to be subject to hostile attacks for purposes of vandalism, theft, fraud, and the like. In an early phase of a network attack, the intruder who is planning an attack will typically gather information about the target system. For example, computer programs known as “network scanners” or “network enumerators” are useful for retrieving user names from networked computers, as well as other information that can facilitate an attack. These and other tools can be used to detect hosts and services, discover network topologies, and to obtain user profile information. Passive data gathering techniques such as sniffing as well as probing by worms and viruses, may also provide the attacker with useful information.

The information-gathering phase is typically followed by activity in which an attempt is made to disrupt the target system, or the discovered vulnerabilities are exploited for other purposes.

Practitioners in the field of network security have developed numerous techniques and devices aimed at mitigating the risk to networks from malicious attacks. Firewalls, for example, are used to prevent unauthorized access to a protected network or system. A firewall, which may be implemented in software or in a dedicated hardware unit, inspects incoming network traffic and grants or withholds access according to whether specified rules are satisfied. In one important function, some firewalls act as a proxy server or concentrator which helps conceal the network addresses in the protected zone or zones behind the firewall.

Although useful, firewalls have limitations. For example, it is common for clients behind a firewall to conduct sessions with external systems using application environments that are susceptible to attack. Also, it is common for a select set of internal systems or services to be made externally accessible. To provide these communications scenarios with external systems, both fixed and dynamic openings in the firewall can be configured, despite the risk.

For this and other reasons, there remains a need for new techniques to augment the security techniques that are already known and implemented.

### SUMMARY OF THE INVENTION

We have developed such a technique. In exemplary embodiments, our new technique comprises storing, in a memory at a node of a computer network, an IP address that is temporarily valid as a destination address for a network destination node.

Further steps include sequentially updating the stored IP address with a plurality of new values that are each temporarily valid as destination IP addresses for said network destination node; comparing destination IP addresses of one or more incoming packets to the stored IP address; and conditionally accepting or rejecting each of said incoming packets according to whether there is a match between the destination IP address of the incoming packet and the temporarily valid IP address currently stored in the memory.

In some embodiments, the temporarily valid IP addresses remain valid for no longer than several times an average exchange latency period for the network. By “exchange latency period” or “exchange latency” is meant the round trip time for a message from one communicating system to reach another and to be processed, and for a reply to be sent and the reply received at its destination and processed. Advantageously, the validity period of the temporary IP address is no more than three times the exchange latency of the network. However, longer validity periods, extending to several minutes or even longer times, will also be useful in some networks.

In some embodiments, the new values of the temporarily valid destination IP address are cryptographically generated.

In some embodiments, the sequential updating of IP address values is synchronized with a corresponding updating of the IP address values at a network node from which the incoming packets are being received.

In some embodiments, the temporarily valid IP address values are updated at specified intervals of time.

### BRIEF DESCRIPTION OF THE DRAWING

FIG. 1 is a protocol diagram illustrating an example of a simple message exchange that might take place between an attacker and a target host in the course of network scanning by the attacker.

FIG. 2 is a protocol diagram illustrating an example of a simple message exchange that might take place between an attacker and a target host in the course of network scanning by the attacker, when the target host is protected by address hopping according to the present invention.

FIG. 3 is a block diagram of a simple, illustrative network that may be protected by address hopping according to the present invention.

FIG. 4 is a block diagram of a network processing chain that has been modified to include modules for carrying out functions that support address hopping.

FIG. 5 is a flowchart of an exemplary process for generating a hopped sequence of IP addresses.

### DETAILED DESCRIPTION

In order for typical packet-based network attacks to be successful, the harmful packets must find their way to the host computer or system that is the intended target. The information that locates the target host in the network is its IP address. Thus, in order to be successful, the intruder generally needs to know the IP address of the target.

As noted above, intruders use network scanners and similar tools to acquire information about host exposures and vulnerabilities. One common technique in the information-gathering phase of an attack is to systematically generate a large set of IP addresses, possibly numbering in the tens of thousands or more, and sending exploratory packets to each of the generated IP addresses in the hope of eliciting responses.

The average roundtrip time between the sending out of a packet to a remote network node, and the receipt of a responsive packet from the remote node, is referred to as the “exchange latency” of the network. Quantitative measures of exchange latency vary widely, depending among other things on the size and complexity of networks, the latencies of particular devices through which packets pass in transit across the networks, the underlying physical technology responsible for packet transport, and the particular applications to which the packets pertain. In a typical national-scale network, the latency might be some tens of milliseconds, but could be much greater.

It will be appreciated that even if an intruder is able to conduct several address scans in parallel, many latency periods will elapse, on average, between positive events, i.e., between returning packets that suggest an exploitable opportunity.

Accordingly, the approach we have developed involves assigning temporarily valid IP addresses to participating hosts. Advantageously, the validity period of a given IP address is shorter than the average time between positive events, as defined above. A tradeoff between processing overhead and improved security will help determine the validity period. For example, we believe it will be particularly useful in many networks to have a validity period in the range, endpoints included, of 50 ms to 200 seconds.

More generally, validity periods from as short as 3 times the average exchange latency of the network, to as long as 10⁵ (one hundred thousand) times the average exchange latency of the network may be useful in some networks. For example, in a network having a latency of 50 ms, a validity period 10⁵ times the latency will last for 1.4 hours, whereas a validity period of 3 times the latency will last for 150 ms.

For comparison, we note that some Internet security researchers have found that it takes as little as four minutes, on average, for an unprotected computer to be compromised after connecting it to the Internet, whereas other researchers have found an average survival time of about 16 hours.

According to our approach, as the validity of the given IP address expires, it is replaced by a new IP address. If the IP addresses expire and are updated often enough, the packets that an intruder sends after a positive event in order to exploit the identified opportunity will be destined for addresses that have become invalid, and will therefore fail to reach their target. Meanwhile, a session that is in progress between the protected node and an authorized remote node may continue without interruption, provided the remote node has the means for generating the updated IP addresses.

Thus, our approach involves updating IP addresses at, e.g., periodic intervals according to a schedule known to both ends of an IP session. By this type of address “hopping”, it is possible to thwart network attacks and information gathering attempts in a manner comparable to the use of frequency hopping to thwart radio jamming attacks.

As noted, various tools are available to the intruder for the purpose of discovering hosts that are active and that may be advantageous to attack. Typically, these tools send probes to specified IP addresses (including probes to various port numbers used by higher-layer protocols) in order to elicit responses indicating that the specified IP address is active, that is, being used by a host or network device, and the status of the identified port, for example open, closed or filtered/blocked.

FIG. 1, to which attention is now directed, illustrates a simple message exchange between an attacker, identified in the figure as client 10, and a target machine, identified as server 20. This message exchange is one of many that may be initiated by the well-known network scanner called “Nmap”.

Message 31 is an example of a “TCP SYN Ping” of port 80. It consists of an empty TCP packet in which the SYN flag is set. Other TCP “pings” can be performed by varying header fields such as the flags and the destination port. Nmap optionally accepts a list of ports as a parameter. The default port is 80, which, as those skilled in the art will understand, signifies HTTP, the Hypertext Transfer Protocol that facilitates exchanges of content on the World Wide Web. Server 20, which in the illustrated example is listening on port 80, receives the Ping and responds with SYN/ACK message 32. (If port 80 were closed, a Reset message would be returned to Client 10, and the message exchange would terminate.)

Client 10 responds with ACK message 33 (directed to the same IP address as message 31). Upon receiving the ACK message, Server 20 may begin to send data, in message 34, to Client 10. Depending on the service running on the host, the data returned in message 34 may include, for example, a banner that identifies an operating system, an application, or the like. Some operating systems, applications, etc., have known vulnerabilities that the intruder may recognize and attempt to exploit.

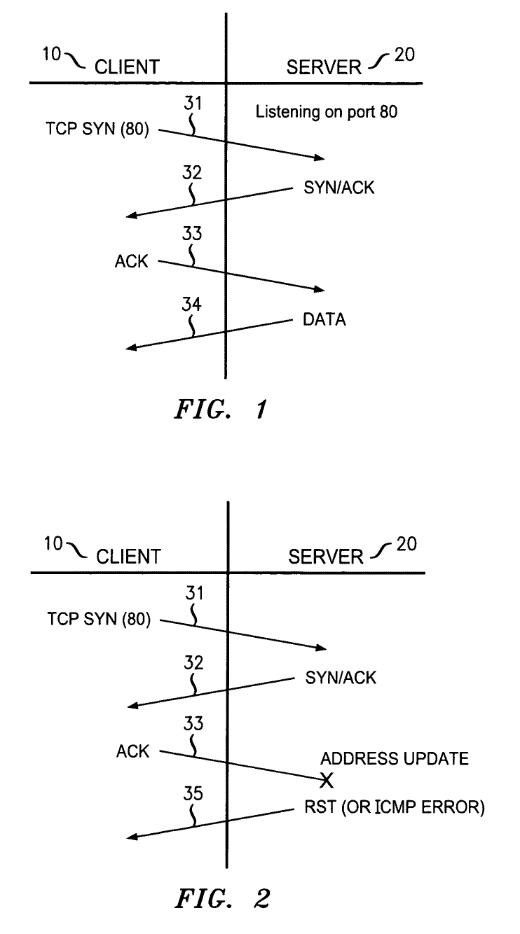

By contrast, FIG. 2 shows what happens when Client 10 attempts to initiate the same message sequence, but the IP address of Server 20 has been updated after the transmission of message 32 but before the receipt of message 33. In this case, ACK message 33 from Client 10 is sent to an inactive IP address, and delivery fails. In that case, Client 10 may receive message 35, which could be, e.g., a RESET message, or else an Internet Control Message Protocol (ICMP) error message from an intermediate router indicating that the host is unreachable. In other embodiments, Client 10 might receive nothing at all, depending on how the network and various packet filters are configured. That is, it will be desirable in at least some cases to configure the protocol stack in the implementing device so as to filter out these reply packets. If no reply packet is sent, the attacker's scan will typically be slowed (the tool will typical resort to a timeout and possibly several retries).

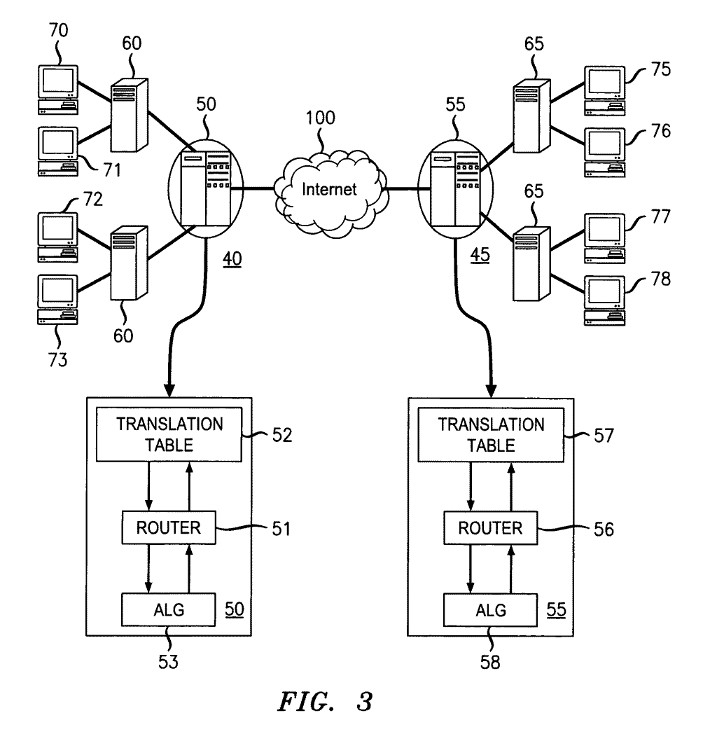

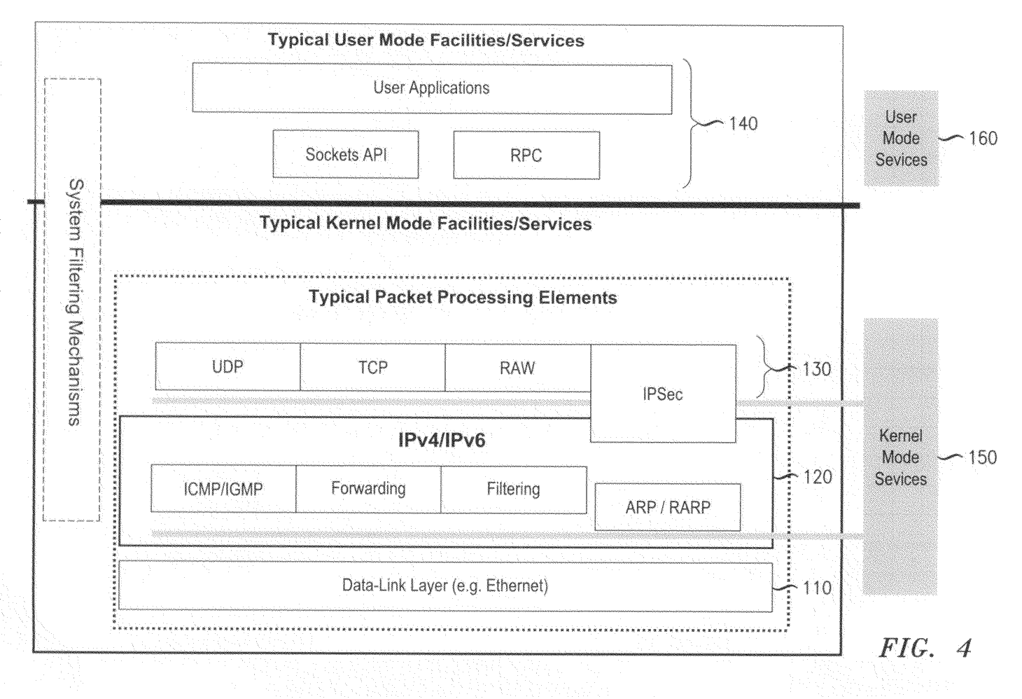

There are several places in the network where the updating of IP addresses may be implemented. By way of illustration, FIG. 3 shows a network in which private subnetworks 40 and 45 communicate with each other over the public Internet 100. Private addresses in subnetwork 40 are protected by middlebox 50, and private addresses in subnetwork 45 are likewise protected by middlebox 55. As illustrated, the portion of subnetwork 40 behind middlebox 50 includes routers 60 and hosts 70-72, and the portion of subnetwork 45 behind middlebox 55 includes routers 65 and hosts 76-78. The combination of functionalities represented in the figure as middlebox 50 may include router 51, translation table 52, and application layer gateway (ALG) 53, and middlebox 55 may likewise include router 56, translation table 57, and ALG 58.

As will be understood by those skilled in the art, router 51 typically uses translation table 52 to map the source addresses of outgoing packets to a public address, and uses state information stored in the translation table to map the destination addresses of responsive incoming packets back to the original addresses. Additional functionality may be needed to process certain application layer packets in which the address information is made part of the payload data. ALG 53 is an example of one type of device (which may be implemented in either hardware or software) that can be used to update payload data based on the address translation.

In the network of FIG. 3, a similar description applies to router 56 and its associated translation table and ALG.

In an example of how our new approach may be implemented, address hopping may be applied to a block of addresses within subnetwork 40, and the new address mappings provided to translation table 52 whenever they are updated. As noted above, it is advantageous to perform these updates as rapidly as needed and at least once per each 10⁵ (one hundred thousand) average exchange latency periods of the network. In many typical environments, the updates will advantageously be performed at least once per minute or even more frequently. Additional updates may be performed upon the exchange of protocol messages between the source and destination nodes. For example, the hosts at the end nodes of a session may use information provided in the exchanged messages as updated inputs to cryptographic algorithms for generating the hopping patterns.

Additionally, it may in some cases be advantageous to make the frequency of updates configurable by the user, up to, e.g., a maximum frequency that is determined by an exchange latency period of the the network. For example, the implementing device could measure the average network latency, and set the minimum period between hops to a multiple of the average latency, such as three times the average latency period.

In an illustrative scenario, middlebox 50 and middlebox 55 have agreed on a hopping scheme that is known to both of them. As a consequence, each middlebox is able to acquire the current hopped IP address in its own, and in the other's, subnetwork for each end node that participates in the hopping scheme. The middleboxes acquire the hopped addresses either by computing them on the fly by a mutually known cryptographic algorithm, or by accessing previously computed and stored values according to a schedule. The computation of hopped address values will be discussed in more detail below.

It should be noted that there is no requirement to apply the hopping scheme to both halves of the communication between two peers. Instead, there may be interactions between hosts such as hosts 70 and 75 of the figure, in which, e.g., host 70 applies hopping to the destination addresses of packets that it is transmitting to host 75, but the address of host 70 is not hopped, and therefore packets sent from host 75 to host 70 do not have hopped destination addresses.

In fact, it may be useful in some cases to configure a network such that a given host has a hopped address relative to network traffic that it receives via one server, whereas it behaves as a typical network node relative to traffic from other servers.

It should also be noted that in the event that, e.g., hosts 70 and 75 are both applying address hopping, the addresses of the respective hosts do not need to be updated simultaneously. Thus, for example, each host might have a different frequency for updating its own hopped addresses.

For purposes of illustration, it is assumed here that in the illustrative scenario, both of hosts 70 and 75 apply address hopping. Accordingly, host 70 transmits an outgoing packet destined for host 75. As the packet passes through middlebox 50, the source address of the outgoing packet is mapped to a current hopped address value of host 70, e.g. 192.168.1.32. (In general, both ports and basic IP addresses may be hopped. In this example, port numbers will be omitted for simplicity. Specific numerical values of basic IP addresses are provided here solely for purposes of illustration and have no special significance.) Additionally, the destination address of the outgoing packet is mapped to a current hopped address value of host 75, e.g., 172.16.76.27.

When the packet arrives at middlebox 55, its destination IP address is recognized as a currently valid hopped address, the middlebox reverses the hopping function by mapping the address back to an IP address it knows for host 75, and the packet is directed to its destination node at host 75. The IP address obtained for the packet by the middlebox when it reverses the hopping function may be an address conventionally assigned, e.g. by DHCP, or as a static IP address.

Before host 75 responds, the hopping patterns for host 70 and for host 75 happen to be updated. Host 75 then transmits a responsive outgoing packet. At middlebox 55, the source address of the packet is mapped to the new hopped address of host 75, which may, e.g., be 172.16.59.11, and the destination address is mapped to the new hopped address of host 70, which may, e.g., be 192.168.152.19.

As will be understood by those skilled in the art, the address-translating functionality of middleboxes 50 and 55 is typically used to map between a relatively large set of private addresses which are known only within a protected subnetwork, and a relatively small set of public addresses, which may be as few as a single public address. In one useful implementation of the ideas described above, the addresses of the hosts lying behind the middleboxes, i.e. the hosts typified by hosts 70-73 and hosts 75-78 of FIG. 3, are not private addresses, but instead are public addresses.

In a second useful implementation, the address-hopping scheme is applied to a block of private addresses that all pertain to the same subnetwork. In that implementation, hosts belonging to the same private subnetwork are protected by the address-hopping scheme from attacking each other, and they are protected from the outside world by the middlebox acting in its conventional role.

In a third useful implementation, the subnetwork, e.g. subnetwork 50 or 55 of FIG. 3, claims a relatively large block of public addresses, and address-hopping is applied to that block, so that each of the one or several active public addresses is varied within a range of possible values. In that implementation, private addresses within the subnetwork remain protected in the conventional way, while the subnetwork as a whole is protected from intrusion through hopping of its public address or public addresses.

A different example of how our new approach may be implemented is an end-to-end hopping scheme, in which each end-host, such as hosts 70-73 and 75-78 of FIG. 3, applies the hopping scheme to update its own IP address. This is readily achieved, if a suitable driver program and software application have been installed on the end host. Suitable software for that purpose is readily acquired or created by routine effort, and need not be described here in detail.

A typical such implementation is embodied in a software module specific to a particular platform or to a particular operating system running on a platform. The module is positioned to lie below the existing packet processing elements of the system, in a manner similar to personal firewall applications. This is desirable because it permits the hopping technique to be applied with minimal impact to existing system functionality and applications.

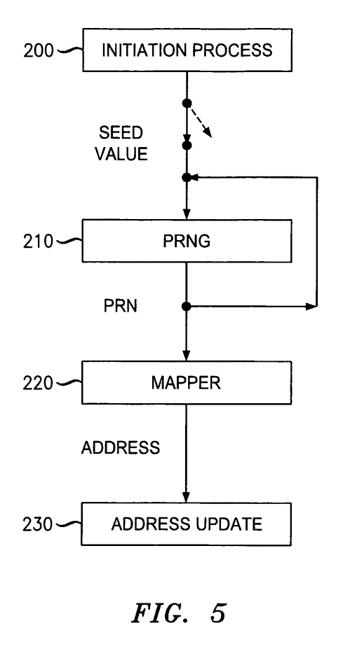

A typical end-host will include a network processing chain, i.e., those elements of the system that receive a packet, from the physical medium up to the user level application network programming interfaces (such as the sockets library). A network processing chain is illustrated in FIG. 4, to which reference is now made.

As seen in the figure, the illustrated network processing chain includes conventional data-link layer 110, Internet layer 120, transport layer 130, and application layer 140. (It will be seen that as illustrated, the block labeled as representing the IPSec protocol suite for supporting secure communications belongs partly to the Internet layer and partly to the transport layer.) In a typical implementation, this chain is augmented by one or more additional kernel level modules or drivers. These new modules 150 support the hopping scheme by implementing the cryptographic algorithms that generate the hopped addresses, the address translation tables, modified routing functions, and, optionally, messaging such as error/debug messaging. User-level configuration and monitoring tools 160 may also be installed, which interact with the kernel-space module or modules 150. Application layer gateway functionality can reside in a kernel module, user-space library, or a combination of the two.

As is well known to those skilled in the art, many networks temporarily store the bindings between IP addresses and MAC addresses in so-called “ARP caches” or the like, which may be situated at end nodes of the network as well as at routers and switches in the network. When processing an inbound packet, a router may attempt to obtain the MAC address of the end-host by searching its ARP cache, using the destination IP address of the packet. If the incoming packet is bearing a hopped destination address, the search for a valid MAC address might fail, particularly if the lifetime of the cached bindings is longer than the hopping period.

For example, suppose a cache has a lifetime of two minutes, the hopping period is 20 seconds, and end-to-end hopping is taking place through a gateway router on a local Ethernet subnet and a remote host. Assume that address hopping is implemented at the end nodes of the local subnet, but is not implemented at the gateway router. When an inbound packet reaches the gateway router, the gateway router consults a route table to identify the interface to be used for forwarding the packet. Because the (hopped) destination address belongs to a block of addresses assigned to the subnet, the gateway router will find a match in the route table. Next, the gateway router consults its ARP cache for a Layer-2 MAC address for the destination node. If, e.g., there is no entry in the cache, the gateway router typically obtains the MAC address by issuing an ARP query and receiving a response. The gateway router then stores the MAC address in its ARP cache, where it will subsist for the cache lifetime of (in this example) two minutes. The next time an inbound packet arrives, the gateway router will repeat the same process. However, it might find that in the ARP cache, an unexpired MAC address is still mapped to the destination IP address of the incoming packet. This may, however, be an invalid MAC address because hopping of the destination IP address has made the cached binding obsolete.

One possible solution is to modify the affected edge router or switch so that it caches the MAC address in the associated binding record for the hopped IP address. (For end-to-end hopping schemes, an appropriately modified ARP filter module would be needed at the affected nodes.) Conventional methods are readily applied for populating, refreshing, and providing for expiration of these records. What is different is that they would need to be associated with the hopping record.

Another possible solution is to configure the affected network elements so that they do not cache, or so that the cache lifetime is short, e.g. comparable to or shorter than a hopping period. The consequence will be to force the network elements to issue ARP queries frequently enough to keep pace with the hopping patterns.

Yet another possible (although atypical) solution is to configure the address-hopped end nodes so that they simply ignore the (generally invalid) destination MAC values present in the Ethernet headers and process all Ethernet frames. This method would require the node to act in what is commonly referred to as promiscuous mode, and to employ Ethernet frame filtering as part of the HADES kernel implementation rather than the simple destination MAC address filtering that is typically performed by the network card or driver.

In end-to-end address-hopping schemes for nodes communicating on the same subnet without intervening switches or routers, the modified ARP capability is desirably supported on each end host.

Turning back to FIG. 3, the implementing device, e.g. middlebox 50, advantageously caches several, e.g. two, most recently valid addresses in addition to the currently valid address, and accepts incoming packets destined for these recent addresses as well as for the current address.

The depth to which previous addresses are cached may be adjusted to prevent, for example, excessive rejections of packets in a network with a relatively short validity period of hopped addresses and relatively long latency or highly variable delay. Packets that are rejected as having invalid addresses (due to untimeliness or other reasons) will typically be treated by upper level protocols in the network as ordinary lost packets. Thus, TCP networks, for example, may attempt to retransmit such packets.

By caching previous destination addresses to some depth, it is possible to accommodate variable delay in the network and still enjoy the added security afforded by the hopping scheme, without a need for explicit timestamps or extra protocol fields in the packets.

An optional feature is for the middlebox (or other implementing device) to cache valid and recently valid source addresses for the nodes that are possible sources of incoming, address-hopped packets. If the source address of an incoming packet matches a cached value, it is likely that the source address came from a remote host using the hopping scheme, and not from an attacker scanning through a massive block of addresses. As a result, greater confidence may be gained that the incoming packet originated at a friendly node.

The block of mappable IP addresses according to the hopping scheme should be large enough that repetitions of the same hopped address are unlikely during the timeframe of an attack, and large enough to defeat an attacker's attempt to identify or profile most or all of the IP addresses in the block.

In general, it will be advantageous to make the block size as large as possible, and preferably larger than, the number of hops that take place over the course of a successful attack. That is, the attacker typically needs some time to gather information about a target system, make some decisions about how to exploit the target system, and then attempt to exploit it. This could require as few as two packet exchanges—one to obtain information and one to exploit it—plus some processing time. Thus, suppose it takes 120 ms for packet exchanges with a Web server to return data that can be used as the basis for attack, and that it takes a further 1 second to select and run a particular exploit, i.e., a particular plan of attack. If the hop frequency is 5 hops per second, then the number of hops that take place over the course of the attack is 5 hops per second×1.12 seconds per attack=5.6 hops per attack. Thus, it is advantageous for the address block to contain at least 6 addresses.

In general, it will be advantageous to make the hopping frequency great enough so that the time between hops is smaller than the minimum time required for an attack. As noted above, the minimum time required for an attack may be as small as two packet round trips, plus some processing time. Thus, for example, in many networks, a hopping frequency in the range 0.005-20 hops per second (endpoints included) will provide a useful amount of added security at the cost of a reasonable amount of added processing load.

In one approach to generating a hopped sequence of IP addresses, as illustrated in FIG. 5, an initiation process 200 provides a seed value to initiate a pseudorandom number generator (PRNG) 210. The output of the PRNG is a sequence of pseudorandom numbers. Typically, each number of the sequence is fed back to generate the next sequential number. In some cases, the pseudorandom numbers output from the PRNG may be directly usable (after appropriate formatting) as IP addresses. In other cases, the output values may be processed further, using techniques that may be as simple as a direct one-to-one mapping, e.g. in mapper 220, to map them to address values for updating (block 230) the hopped address.

The initial seed value may be exchanged between a pair of nodes wishing to establish a mutually synchronized hopping scheme. Any of various well known key-exchange protocols may be used for that purpose. In one possible approach, for example, host A and host B wish to communicate, and each host knows the other's DNS name.

Additionally, hosts A and B have a shared secret, that may, for example, have been configured when the hosts were registered with the network. Communicating over a control channel, Host A, for example, performs a DNS query using host B's DNS hostname and the shared secret, to obtain the current seed value needed to synchronize with host B for communication. For example, the shared secret might be used to compute an authentication signature for the exchanged messages. For added security, host B could encrypt the seed value before sending it to A.

In alternative approaches, a shared secret or shared secrets may be directly configured onto both host A and host B.

After a synchronized hopping scheme has been established between a pair of nodes, they may periodically check, e.g. with a trusted third party, to ensure that the credentials or seed values that have been exchanged are still valid. In such a configuration, it would be possible, as an added benefit, to revoke a node's participation in the hopping scheme even during ongoing communications between the peers. Advantageously, the period between such periodic checks would be a configurable value of, e.g., ten minutes or more. A further check would advantageously be performed in the event of a connection failure.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

The functions of the various elements shown in the figures, including any functional blocks labeled as processors or the like, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

What is claimed is:

1. A method, comprising:
storing in a memory, at a node of a computer network, an IP address that is temporarily valid as a destination address for a network destination node;
sequentially updating the stored IP address with a plurality of new values that are each temporarily valid as destination IP addresses for said network destination node;
comparing destination IP addresses of one or more incoming packets to the stored IP address; and
conditionally accepting or rejecting each of said incoming packets according to whether there is a match between the destination IP address of the incoming packet and the temporarily valid IP address currently stored in the memory, wherein:
the temporarily valid IP address values are updated at least at specified intervals of time;
the specified intervals of time occur at least once per 200 seconds; and
the new values of the temporarily valid IP addresses are generated using an algorithm that is synchronized with a similar algorithm at least at one remote node of the network.

2. The method of claim 1, wherein said specified intervals of time occur at most once per 50 ms.

3. The method of claim 1, wherein the network has an average exchange latency period, and the specified intervals of time occur at least once per 100,000 said latency periods.

4. The method of claim 1, wherein the network has an average exchange latency period, and the specified intervals of time occur at most once per three said latency periods.

5. The method of claim 1, wherein said specified intervals of time have a frequency that is configurable up to a maximum value determined by an exchange latency period of the the network.

6. The method of claim 1, wherein the new values of the temporarily valid destination IP address are cryptographically generated.

7. The method of claim 1, wherein the sequential updating of IP address values is performed cryptographically, using shared secret data that is also possessed by a network node from which the incoming packets are being received.

8. The method of claim 1, wherein the sequential updating of IP address values is synchronized with a corresponding updating of the IP address values at a source network node from which the incoming packets are being received.

9. The method of claim 1, wherein the temporarily valid IP address values are further updated in response to the exchange of protocol messages with a network node from which the incoming packets are being received.

10. The method of claim 1, performed at the network destination node.

11. The method of claim 1, performed at one or more intermediate network nodes situated upstream of the destination network node relative to the incoming packets.

12. The method of claim 8, further comprising performing a network address translation on the destination IP addresses of one or more incoming packets that have been accepted.

13. The method of claim 1, further comprising exchanging secret data with a remote network node, and using the secret data to cryptographically generate the new values of the temporarily valid destination IP address, and wherein the incoming packets are received from the remote network node.

14. The method of claim 1, wherein the stored IP address is updated at least once during an IP session between endpoints of the network, and the stored and updated IP address designates one of the endpoints participating in the IP session.

15. An article of manufacture, comprising a computer usable medium having computer readable program code embodied therein, wherein the computer readable program code comprises:
code for causing a computer to store, in a memory at a node of a computer network, an IP address that is temporarily valid as a destination address for a network destination node;
code for generating a plurality of new IP address values synchronously with similar code running at least at one remote node;
code for causing the computer, at least at specified intervals occurring at least once per 200 seconds, to sequentially update the stored IP address with said plurality of new values such that each updated address is temporarily valid as a destination IP addresses for said network destination node, wherein the temporarily valid IP address values are updated at least at specified intervals of time that are separated by at most 200 seconds;
code for causing the computer to compare destination IP addresses of one or more incoming packets to the stored IP address; and
code for causing the computer to conditionally accept or reject each of said incoming packets according to whether there is a match between the destination IP address of the incoming packet and the temporarily valid IP address currently stored in the memory.
